(19) United States
(12) Patent Application Publication
(10) Pub. No.: US 2012/0244423 A1
(43) Pub. Date: Sep. 27, 2012

(54) LAMINATE CASE SECONDARY BATTERY

(75) Inventors: Masao Kusukawa, Osaka (JP); Masayuki Fujiwara, Kasai-shi (JP); Yoshitaka Shinyashiki, Kobe-shi (JP)

(73) Assignee: SANYO Electric Co., Ltd., Osaka (JP)

(21) Appl. No.: 13/427,498

(22) Filed: Mar. 22, 2012

(30) Foreign Application Priority Data
Mar. 23, 2011 (JP) 2011-063544

(51) Int. Cl. H01M 2/30; H01M 2/02

(52) U.S. Cl. 429/178

(57) ABSTRACT

A positive electrode current collector terminal (15) has an L-shape in side view having a first piece (15a) substantially parallel to positive electrode plates (1) and negative electrode plates (2) in a stacked electrode assembly (10), and a second piece (15b) substantially parallel to a stacking direction of the positive electrode plates (1) and the negative electrode plates (2) of the stacked electrode assembly (10). Positive electrode current collector leads (11) are joined to the second piece (15b) of the positive electrode current collector terminal (15), and a glass tape (20) is affixed in a staking direction-wise fore-end region (15d) of a surface of the second piece (15b) facing the laminate battery case, the staking direction being the stacking direction of the positive electrode plates (1) and the negative electrode plates (2) of the stacked electrode assembly (10).

### BACKGROUND OF THE INVENTION

1. Field of the Invention

The present invention relates to laminate case secondary batteries, and more particularly to a laminate case secondary battery having a current collector terminal having an L-shape in side view.

2. Description of Related Art

Power sources for robots and electric vehicle and backup power sources, for example, require high capacity and high rate performance. Lithium-ion batteries, which offer high energy density, have attracted attention as they meet such requirements.

The battery configurations of the lithium-ion batteries are broadly grouped into two types. One is what is called a spirally-wound type battery. It has an electrode assembly, enclosed in a battery case, and the electrode assembly comprises a positive electrode plate and a negative electrode plate that are spirally wound together with separators interposed therebetween. The other one is what is called a stack type battery. It has a stacked electrode assembly enclosed in a battery case, and the stacked electrode assembly comprises positive electrode plates and negative electrode plates in a square shape that are stacked alternately together with separators interposed therebetween.

Of the two types of battery configurations, the latter type of stack type battery has a stacked electrode assembly having the following structure. The stacked electrode assembly has a required number of positive electrode plates, each having a positive electrode current collector lead protruding therefrom, and a required number of negative electrode plates, each having a negative electrode current collector lead protruding therefrom. The positive electrode plates and the negative electrode plates are stacked with separators having substantially the same shape as the negative electrode plates. The current collector leads protruding from the respective electrode plates are joined respectively to the positive and negative electrode current collector terminals.

Regarding the parts in which the positive and negative electrode current collector leads protruding from the respective electrode plates are joined to the positive and negative electrode current collector terminals in the stack type battery (the parts being hereinafter also referred to as “positive and negative electrode current collector elements”), the following structures, for example, have been proposed in order to improve the connection reliability between the positive and negative electrode current collector leads and the positive and negative electrode current collector terminals and to reduce the space occupied by the positive and negative electrode current collector elements.

Japanese Published Unexamined Patent Application No. 2009-187768 (Patent Document 1) discloses that the positive and negative electrode terminals (current collector leads) protruding from the electrode plates of the positive and negative electrodes are bent to improve space efficiency, and the positive and negative electrode terminals are provided with slack in advance before folding them, to thereby prevent stretching, wrinkles, twist, etc. of the positive and negative electrode terminals.

As the battery case for lithium-ion batteries, it is preferable to use a laminate battery case using a laminate film having insulating layers (resin layers) on opposite faces of a metal foil, in order to reduce the weight and thickness of the battery case.

In a laminate case secondary battery employing the laminate battery case, one end of each of the current collector terminals of the positive and negative electrodes extends outside of the battery case. To the other end thereof that is disposed inside the battery case, a plurality of current collector leads connected to respective electrode plates are connected.

In such a battery, the heat produced when passing high current therethrough tends to concentrate in the other ends of the positive electrode current collector terminal and the negative electrode current collector terminal, which are disposed inside the battery case, so the temperature of the other ends of the positive electrode current collector terminal and the negative electrode current collector terminal may rise significantly. When the temperature of the other ends of the positive electrode current collector terminal and the negative electrode current collector terminal excessively rises, the inner insulating layer (resin layer) of the laminate battery is melted by the heat generation from the positive electrode current collector terminal and the negative electrode current collector terminal, and the metal foil is exposed. Consequently, an electrical short circuit occurs between the metal foil and the positive and negative electrode current collector terminals, or between the positive electrode current collector leads and the negative electrode current collector leads.

In order to solve such a problem, Japanese Published Unexamined Patent Application No. 2004-87260 (Patent Document 2) proposes the following technique. The thickness of the joined part of the positive electrode tab (current collector terminal) to which a plurality of positive electrode leads are joined is made larger than the thickness of the other part of the positive electrode tab (current collector terminal), and also the thickness of the joined part of the negative electrode tab (current collector terminal) to which a plurality of negative electrode leads are joined is made larger than the thickness of the other part of the negative electrode tab (current collector terminal). Thereby, the heat capacity in the joined parts in which heat concentrates when passing high current therethrough is increased to inhibit the temperature rise of the positive electrode tab (current collector terminal) and the negative electrode tab (current collector terminal).

Japanese Published Unexamined Patent Application No. 2004-87260 (Patent Document 2) also discloses another method of increasing the heat capacity in the region in which heat concentrates when passing high current therethrough, by disposing a composite material in which metal particles or ceramic particles are dispersed in polyolefin, for example.

The batteries using a laminate battery case have the risk of causing the inner insulating layer of the laminate battery case to melt when abnormality arises in the battery and a current collector terminal undergoes abnormal heat generation, resulting in making the current collector terminal and the metal layer of the laminate battery case direct contact with each other and causing a short circuit.

### BRIEF SUMMARY OF THE INVENTION

Accordingly, it is an object of the present invention to solve the foregoing and other problems and to provide a laminate case secondary battery with higher level of safety.

In order to accomplish the foregoing and other objects, the present invention provides a laminate case secondary battery comprising: a stacked electrode assembly and a laminate battery case enclosing the stacked electrode assembly, the stacked electrode assembly comprising a plurality of positive electrode plates and a plurality of negative electrode plates being alternately stacked one another across separators, a plurality of positive electrode current collector leads and a plurality of negative electrode current collector leads protruding respectively from the positive electrode plates and the negative electrode plates and being respectively stacked on and joined to a positive electrode current collector terminal and a negative electrode current collector terminal, wherein: at least one of the positive electrode current collector terminal and the negative electrode current collector terminal has an L-shape in side view having a first piece substantially parallel to the positive electrode plates and the negative electrode plates of the stacked electrode assembly and a second piece substantially parallel to a stacking direction of the positive electrode plates and the negative electrode plates of the stacked electrode assembly; at least one of the positive electrode current collector leads and the negative electrode current collector leads is joined to the second piece of the at least one of the positive electrode current collector terminal and the negative electrode current collector terminal; and a glass tape is affixed to a stacking direction-wise fore-end region of a surface of the second piece, the surface of the second piece facing the laminate battery base, and the stacking direction being the stacking direction of the positive electrode plates and the negative electrode plates of the stacked electrode assembly.

The present invention makes it possible to inhibit the melting of the inner insulating layer of the laminate battery case even when a current collector terminal produces abnormal heat and to prevent the current collector terminal and the metal layer of the laminate battery case from making direct contact with each other even when the inner insulating layer of the laminate battery case has been melted. As a result, the present invention makes it possible to provide a battery offering a higher level of safety.

### BRIEF DESCRIPTION OF THE DRAWINGS

FIG. 1 shows portions of a laminate case secondary battery according to the present invention, wherein FIG. 1(a) is a plan view illustrating a positive electrode plate used therefor, FIG. 1(b) is a plan view illustrating a separator used therefor, and FIG. 1(c) is a plan view illustrating a pouch-shaped separator thereof in which a positive electrode plate is disposed;

FIG. 2 is a plan view illustrating a negative electrode plate used for the laminate case secondary battery of the present invention;

FIG. 3 is an exploded perspective view illustrating a stacked electrode assembly used for the laminate case secondary battery according to the present invention;

FIG. 4 is a plan view illustrating the stacked electrode assembly used for the laminate case secondary battery according to the present invention;

FIG. 5 is a side view illustrating how the first step (bundling and cutting of positive and negative electrode current collector leads) in the manufacturing process of the laminate case secondary battery according to the present invention is carried out;

FIG. 6 is a side view illustrating how the second step (connecting of positive and negative electrode current collector terminals) in the manufacturing process of the laminate case secondary battery according to the present invention is carried out;

FIG. 7 is a side view illustrating how the third step (bending of positive and negative electrode current collector terminals) in the manufacturing process of the laminate case secondary battery according to the present invention is carried out;

FIG. 8 is a side view illustrating how the fourth step (bending of positive and negative electrode current collector joint portions) in the manufacturing process of the laminate case secondary battery according to the present invention is carried out;

FIG. 9 is a side view illustrating how the fifth step (affixing of glass tape) in the manufacturing process of the laminate case secondary battery according to the present invention is carried out;

FIG. 10 is a side view illustrating how the sixth step (coating by an insulating layer) in the manufacturing process of the laminate case secondary battery according to the present invention is carried out;

FIG. 11 is a perspective view illustrating a laminate case secondary battery of the present invention;

FIG. 12 is a schematic cross-sectional view taken along line D-D in FIG. 11; and

FIG. 13 is a cross-sectional view of a laminate case secondary battery illustrating a second embodiment of the present invention.

### DETAILED DESCRIPTION OF THE INVENTION

The present invention provides a laminate case secondary battery comprising: a stacked electrode assembly and a laminate battery case enclosing the stacked electrode assembly, the stacked electrode assembly comprising a plurality of positive electrode plates and a plurality of negative electrode plates being alternately stacked one another across separators, a plurality of positive electrode current collector leads and a plurality of negative electrode current collector leads protruding respectively from the positive electrode plates and the negative electrode plates and being respectively stacked on and joined to a positive electrode current collector terminal and a negative electrode current collector terminal, wherein: at least one of the positive electrode current collector terminal and the negative electrode current collector terminal has an L-shape in side view having a first piece substantially parallel to the positive electrode plates and the negative electrode plates of the stacked electrode assembly and a second piece substantially parallel to a stacking direction of the positive electrode plates and the negative electrode plates of the stacked electrode assembly; at least one of the positive electrode current collector leads and the negative electrode current collector leads is joined to the second piece of the at least one of the positive electrode current collector terminal and the negative electrode current collector terminal; and a glass tape is affixed to a stacking direction-wise fore-end region of a surface of the second piece, the surface of the second piece facing the laminate battery base, and the stacking direction being the stacking direction of the positive electrode plates and the negative electrode plates of the stacked electrode assembly.

The present inventors have found that the melting of the inner insulating layer of the laminate battery case that occurs when a current collector terminal produces abnormal heat is apt to occur especially when using a current collector terminal having an L-shape in side view, and that it is particularly apt to occur in a stacking direction-wise fore-end region (the end region opposite to the boundary line between the first piece and the second piece) of the surface of the second piece of the current collector terminal that faces the laminate battery base, the stacking direction being the stacking direction of the positive electrode plates and the negative electrode plates of the stacked electrode assembly.

The present invention can inhibit the inner insulating layer of the laminate battery case from melting by affixing a glass tape, which is excellent in heat resistance, to this region in which the melting of the inner insulating layer of the laminate battery case is apt to occur, even when the current collector terminal produces abnormal heat. Moreover, the invention makes it possible to prevent the current collector terminal and the metal layer of the laminate battery case from directly making contact with each other even when the inner insulating layer of the laminate battery case has been melted.

In the present invention, the phrase “substantially parallel” means to include not only a state in which an object is strictly (or completely) parallel to another object but also a state in which the object is inclined with respect to the other object to a certain degree (for example, from +10° to −10°). In addition, the phrase “having an L-shape in side view” does not mean that the first piece and the second piece are strictly perpendicular to each other, but it means to include a state in which the first piece and the second piece are inclined with respect to each other to a certain degree.

The glass tape may be one having heat resistance (250° C. or higher) and electrical insulation capability. More specifically, it is possible to use a tape in which an adhesive agent is coated on a glass cloth made of glass fiber. A preferable example of the adhesive agent is a silicone-based adhesive agent.

In the present invention, it is preferable that the current collector terminal and the current collector leads are covered with an insulating layer containing ceramic particles.

In order to improve the battery safety, it is preferable that the current collector terminal and the current collector leads facing the laminate battery case be covered with an insulating layer. However, the glass tape is thicker and harder than ordinary plastic tapes, so it is difficult to affix to the entire region of the current collector terminal and the current collector leads, and more difficult especially when the current collector terminal and the current collector leads are bent.

On the other hand, with the insulating layer containing ceramic particles, the heat resistance of the insulating layer can be improved by the ceramic particles, and moreover, the bent portions of the current collector terminal and the current collector leads can be covered easily. Thus, when the region of the current collector terminal and the current collector leads that is not covered by the glass tape is covered with the insulating layer containing ceramic particles, a battery with a higher level of safety can be obtained easily.

It may appear possible to cover the current collector terminal and the current collector leads with the insulating layer containing ceramic particles, without affixing the glass tape to the fore-end region of the second piece of the current collector terminal. However, in the case of the insulating layer containing ceramic particles, the insulating layer in the fore-end region of the second piece of the current collector terminal may peel off when the insulating layer makes contact with the laminate battery case. For this reason, it is preferable that the glass tape be affixed to this region.

In the present invention, it is preferable that the insulating layer contain ceramic particles and a binder agent. Usable examples of the binder agent include styrene-butadiene rubber (SBR), carboxymethylcellulose (CMC), and polyvinylidene fluoride (FVdF). The use of SBR is especially preferable. Usable examples of the material of the ceramic particles contained in the insulating layer include alumina, zirconia, titania, and mullite. It is preferable that the amount of the ceramic particles in the insulating layer containing the ceramic particles be from 85 mass % to 98 mass %, more preferably from 90 mass % to 98 mass %, with respect to the total amount of the insulating layer containing the ceramic particles.

In the present invention, it is preferable that the glass tape be affixed to an outer face of a boundary region between the first piece and the second piece of the current collector terminal.

The melting of the inner insulating layer of the laminate battery case that takes place when the current collector terminal produces abnormal heat is apt to occur also in a region facing the outer face of the boundary region between the first piece and the second piece of the current collector terminal (i.e., the outer face of the bent portion). Accordingly, when the glass tape is affixed to this region, a battery with an even higher level of safety can be obtained.

Hereinbelow, with reference to the drawings, the present invention is described in further detail based on certain embodiments and examples thereof. It should be construed, however, that the present invention is not limited to the following embodiments and examples, and various changes and modifications are possible without departing from the scope of the invention.

### First Embodiment

### Preparation of Positive Electrode Plate

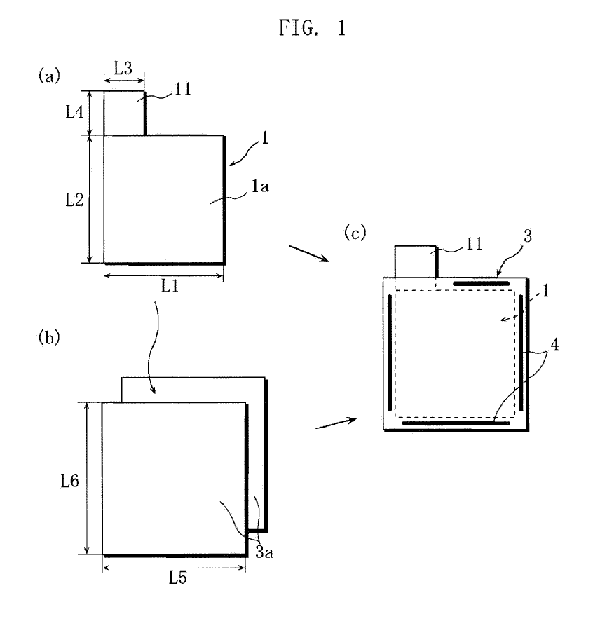

90 mass % of LiCoO₂ as a positive electrode active material, 5 mass % of carbon black as a conductive agent, and 5 mass % of polyvinylidene fluoride as a binder agent were mixed with an N-methyl-2-pyrrolidone (NMP) solution as a solvent to prepare a positive electrode mixture slurry. The resultant positive electrode slurry was applied onto both sides of an aluminum foil (thickness: 15 nm) serving as a positive electrode current collector. Thereafter, the material was heated to remove the solvent and compressed with rollers to a thickness of 0.1 mm Subsequently, as illustrated in FIG. 1(a), it was cut into pieces each having a width L1 of 85 mm and a height L2 of 85 mm, to prepare positive electrode plates 1 each having a positive electrode active material layer 1a on each side. At this point, in each of the positive electrode plates 1, an active material-uncoated portion having a width L3=30 mm and a height L4=20 mm was allowed to protrude outwardly from one end (the left end in FIG. 1(a)) of one side of the positive electrode plate 1 that extends along the width L1, to form a positive electrode current collector lead 11.

### Preparation of Negative Electrode Plate

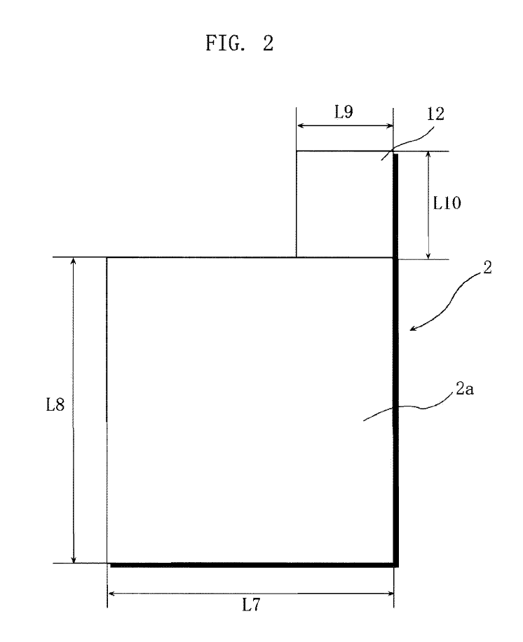

96 mass % of graphite powder as a negative electrode active material, and 2 mass % of carboxymethylcellulose (CMC) and 2 mass % of styrene-butadiene rubber (SBR) as binder agents were mixed with pure water as a solvent, to form a negative electrode slurry. The resultant negative electrode slurry was applied onto both sides of a copper foil (thickness: 10 μm) serving as a negative electrode current collector. Thereafter, the material was heated to remove the solvent and compressed with rollers to a thickness of 0.08 mm. Subsequently, as illustrated in FIG. 2, it was cut into pieces each having a width L7 of 90 mm and a height L8 of 90 mm, to prepare negative electrode plates 2 each having a negative electrode active material layer 2a on each side. At this point, in each of the negative electrode plates 2, an active material-uncoated portion having a width L9 of 30 mm and a height L10 of 20 mm was allowed to protrude outwardly from one end (the right end in FIG. 2) of the negative electrode plate 2 that is opposite to the side end thereof at which the positive electrode lead 11 was formed, in one side of the negative electrode plate 2 that extends along the widthwise direction, to form a negative electrode lead 12.

Preparation of Pouch-Type Separator in which the Positive Electrode Plate is Disposed

The positive electrode plate 1 was disposed between two square-shaped polypropylene (PP) separators 3a (thickness: 30 nm) as illustrated in FIG. 1(b), each having a width L5 of 90 mm and a height L6 of 94 mm. Thereafter, as illustrated in FIG. 1(c), the three sides of the separators 3a, other than the side from which the positive electrode current collector lead 11 protrudes, were thermally sealed at a sealing part 4, to prepare a pouch-type separator 3, in which the positive electrode plate 1 was accommodated. The separator 3a is shaped so that the height L6=94 mm is 4 mm greater than the height L8=90 mm of the negative electrode plate 2. Therefore, the separator 3a protrudes from the pouch-type separator 3 over the negative electrode plate 2 in the direction in which the positive electrode current collector lead 11 protrudes.

### Preparation of Stacked Electrode Assembly

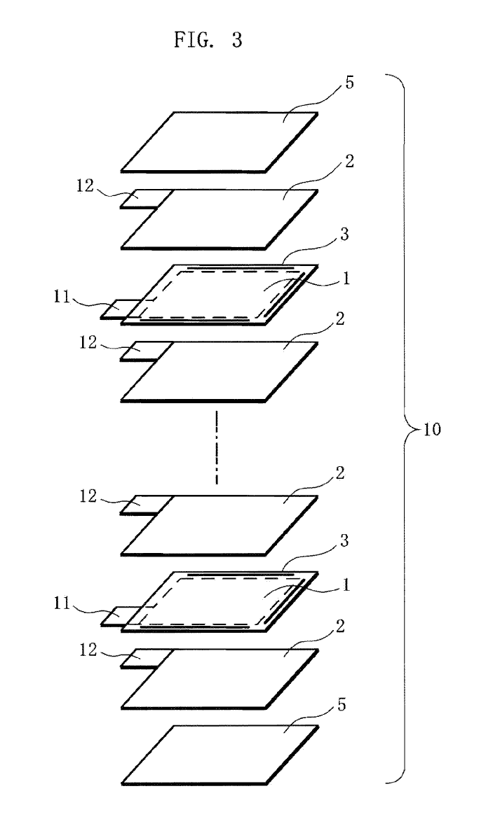

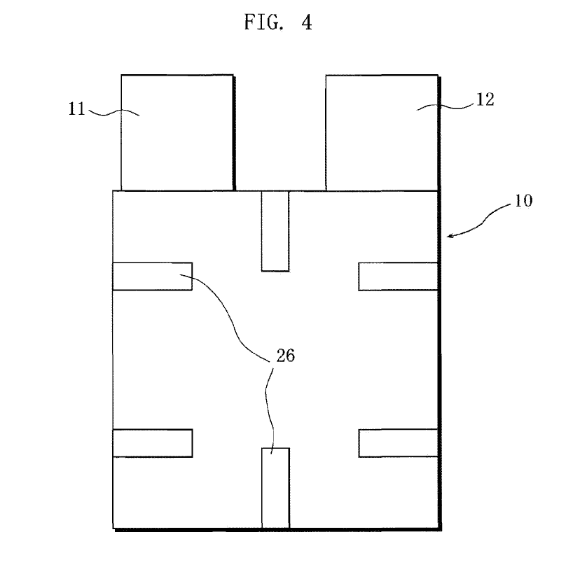

35 sheets of the pouch-shaped separators 3 in each of which the positive electrode plate 1 was disposed, and 36 sheets of the negative electrode plates 2 were prepared, and the pouch-shaped separators 3 and the negative electrode plates 2 were alternately stacked one on the other, as illustrated in FIG. 3. Then, negative electrode plates 2 were placed at both stacking direction-wise ends of the stack, and insulating sheets 5 made of polypropylene (PP) and having the same dimensions and the same shape as the separator 3a were disposed on respective further outer sides thereof. Subsequently, as illustrated in FIG. 4, the top and bottom faces of the stacked component were connected by insulating tapes 26 for retaining its shape. Thus, a stacked electrode assembly 10 was obtained.

### Shaping and Connecting of Current Collectors

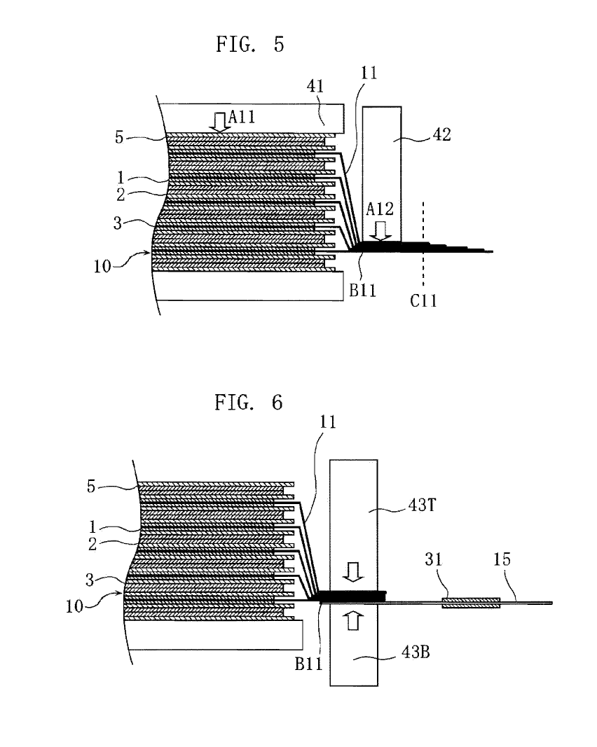

Shaping (bundling, cutting, bending, etc.) of the positive and negative electrode current collector leads 11 and 12 of the stacked electrode assembly 10 and connecting thereof with the positive and negative electrode current collector terminals 15 and 16 were carried out according to the following steps a) through f). It should be noted that although the following description and in FIGS. 5 through 10, which schematically show the manufacturing process, basically illustrate processing of the positive electrode side (positive electrode current collector leads 11 and a positive electrode current collector terminal 15), the negative electrode side is also processed in a like manner.

### a) First Step (Bundling and Cutting of Positive and Negative Electrode Current Collector Leads)

As illustrated in FIG. 5, while the stacked electrode assembly 10 was being retained by a workpiece clamp 41 such as to be sandwiched and compressed from the top and the bottom as indicated by arrow A11, the stacked positive electrode current collector leads 11 were collectively pressed downward from the top using a bundling head 42, as indicated by arrow A12. In this way, the stacked positive electrode current collector leads 11 were bundled in such a manner as to be gathered at one stacking direction-wise side (the lower side in FIG. 5) of the stacked electrode assembly 10. Subsequently, at a cut position C11, an excess portion was cut off from the portion of the positive electrode current collector leads 11 extending from a bundled portion B11 toward the distal end thereof, so that the distal ends were at the same position.

b) Second Step (Connecting Positive and Negative Electrode Current Collector Terminals)

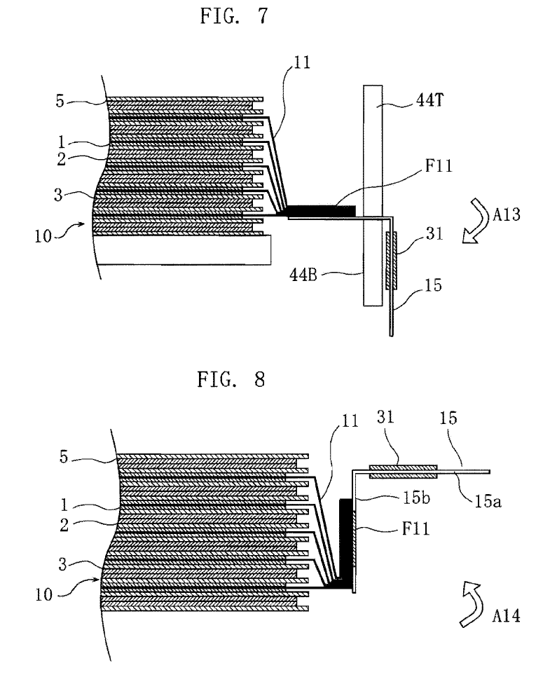

As illustrated in FIG. 6, a positive electrode current collector terminal 15 made of an aluminum plate having a width of 30 mm and a thickness of 0.4 mm was placed below the bundled portion B11 of the positive electrode current collector leads 11 so as to be overlapped therewith. Under this condition, an ultrasonic horn 43T and an anvil 43B were set to perform ultrasonic welding. Thereby, a positive electrode current collector joint portion F11 (FIG. 7), in which the positive electrode current collector leads 11 and the positive electrode current collector terminal 15 are joined to each other, is formed. Likewise, a negative electrode current collector terminal 16 made of a copper plate having a width of 30 mm and a thickness of 0.4 mm was joined to the negative electrode current collector leads 12.

Note that reference numeral 31 shown in FIG. 6 denotes a resin sealing material, formed so as to be firmly bonded to each of the positive and negative electrode current collector terminals 15 and 16 in a strip shape along the widthwise direction, for ensuring hermeticity when heat-sealing a later-described laminate battery case 18.

### d) Third Step (Bending of the Positive and Negative Electrode Current Collector Terminals)

As illustrated in FIG. 7, while the positive electrode current collector terminal 15 was being retained so as to be pressed from the top and the bottom by retaining members 45T and 45B, a portion of the positive electrode current collector terminal 15 that protrudes from the positive electrode current collector joint portion F11 toward the distal end was bent so as to have an L-shape in side view, as indicated by arrow A13.

### d) Fourth Step (Bending of the Positive and Negative Electrode Current Collector Joint Portions)

As illustrated in FIG. 8, the positive electrode current collector joint portion F11 was bent in the manner as indicated by arrow A14, at a portion nearer the positive and negative electrode plates 1 and 2 (the base end portion of the positive electrode current collector leads 11) than the positive electrode current collector joint portion F11 so that the positive electrode current collector joint portion F11 would be substantially parallel to the stacking direction (the vertical direction in FIG. 8) of the stacked electrode assembly 10. Here, a portion of the positive electrode current collector terminal 15 that is substantially parallel to the positive electrode plates 1 and the negative electrode plates 2 of the stacked electrode assembly 10 is a first piece 15a, and a portion of the positive electrode current collector terminal 15 that is substantially parallel to a stacking direction (a vertical direction in FIG. 8) of the positive electrode plates 1 and the negative electrode plates 2 of the stacked electrode assembly 10 is a second piece 15b.

### e) Fifth Step (Affixing of Glass Tape)

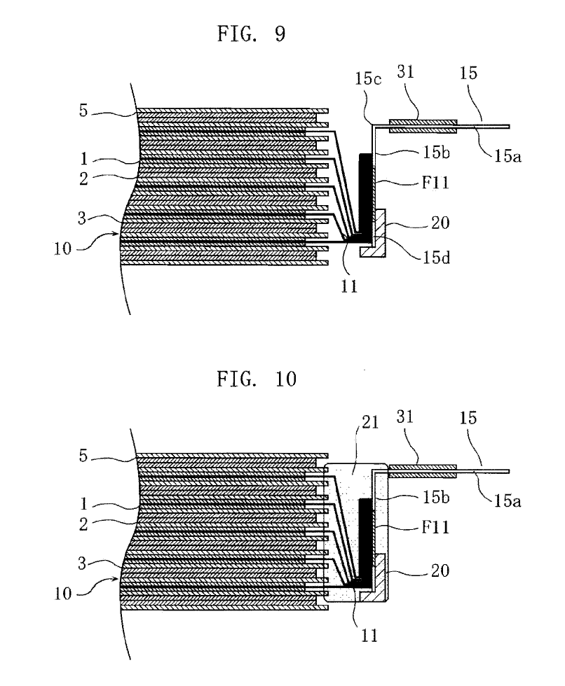

As illustrated in FIG. 9, a glass tape 20 was affixed to a stacking direction-wise fore-end region 15d of the second piece 15b of the positive electrode current collector terminal 15 (i.e., an end region of the positive electrode current collector terminal that is opposite to a boundary line 15c between the first piece 15a and the second piece 15b), in a surface thereof facing the laminate battery case (that is, in the surface of the second to piece that is opposite to the side of the second piece on which the positive electrode current collector leads 11 are connected), the stacking direction being the stacking direction of the positive electrode plates 1 and the negative electrode plates 2 of the stacked electrode assembly 10.

c) Sixth Step (Covering with Insulating Layer)

As illustrated in FIG. 10, the positive electrode current collector terminal 15 and the positive electrode current collector leads 11 were coated with an insulating layer 21 comprising alumina particles and styrene-butadiene rubber (SBR). In the insulating layer 21, the mass ratio of the alumina particles and the SBR was set at 9:1.

### Placing the Electrode Assembly in Battery Case

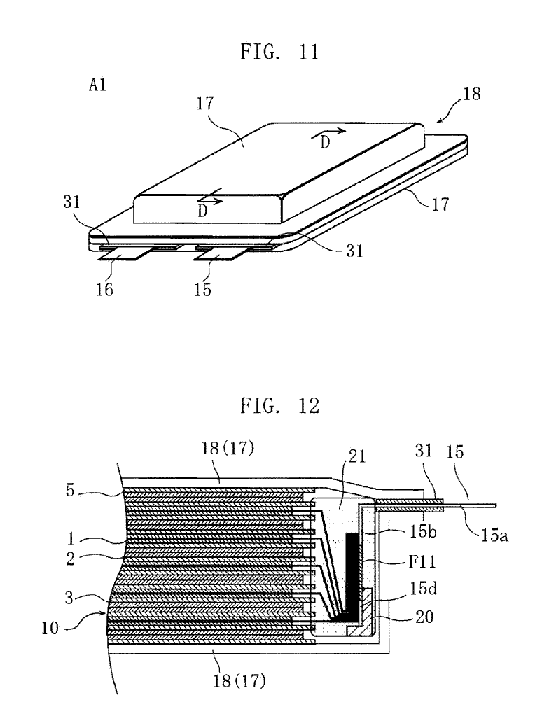

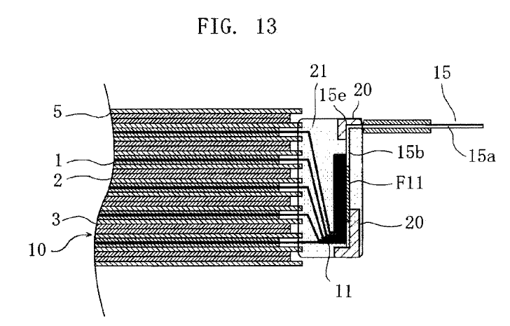

As illustrated in FIG. 11, the above-described stacked electrode assembly 10 was inserted into a battery case 18 formed of laminate films 17, which had been shaped in advance so that the stacked electrode assembly 10 could be placed therein. Then, the peripheral sides of the battery case 18, except for the peripheral side in which the positive electrode current collector terminal 15 and the negative electrode current collector terminal 16 were placed, were thermally welded together so that only the positive electrode current collector terminal 15 and the negative electrode current collector terminal 16 would protrude outwardly from the battery case 18. FIG. 12 is a schematic cross-sectional view taken along line D-D in FIG. 11. As illustrated in FIG. 12, the glass tape 20 is affixed to the stacking direction-wise fore-end region 15d in the surface of the second piece 15b of the positive electrode current collector terminal 15 that faces the laminate battery case 18 (the laminate film 17), the stacking direction being the stacking direction of the positive electrode plates 1 and the negative electrode plates 2 of the stacked electrode assembly 10.

### Filling Electrolyte Solution and Sealing the Battery Case

An electrolyte solution was prepared by dissolving LiPF₆ at a concentration of 1 M (mol/L) in a mixed solvent of 30:70 volume ratio of ethylene carbonate (EC) and methyl ethyl carbonate (MEC). The electrolyte solution was filled into the battery case 18 from the one peripheral side of the battery case 18 that was not yet thermally welded. Lastly, the one peripheral side of the battery case 18 that had not been thermally welded was thermally welded, to prepare a battery A1.

The configuration of the above-described battery A1 makes it possible to obtain a battery with a high level of safety, which prevents a short circuit between the current collector terminals and the metal layer of the laminate battery case.

### Second Embodiment

In a second embodiment, a glass tape 20 was affixed to an outer face of a boundary region 15e between the first piece 15a and the second piece 15b of the positive electrode current collector terminal 15 (i.e., on the outer face at the bent portion), as illustrated in FIG. 13, in addition to the configuration shown in the first embodiment. This makes it possible to obtain a battery providing a higher level of safety.

### Other Embodiments

Although the advantageous effects of the present invention can be obtained even when the invention is applied to only one of the positive electrode side and the negative electrode side, it is preferable that the invention is applied to both the positive electrode side and the negative electrode side.

In the present invention battery A1, the positive electrode current collector terminal 15 and the negative electrode current collector terminal 16 were made of an aluminum plate and a copper plate, respectively. However, each of the positive electrode current collector terminal 15 and the negative electrode current collector terminal 16 may be made of a nickel plate.

For the laminate battery case in the present invention, it is possible to use one in which an insulating layer is formed on at least one surface of a metal layer (on an inner side of the battery), and it is preferable to use one in which the insulating layer is formed on both surfaces of the metal layer. Usable examples of the material for the metal layer include aluminum, aluminum alloys, and stainless steel. Usable examples of the material for the inner layer (inner side of the battery) include polyethylene and polypropylene, and usable examples of the material for the outer layer (outer side of the battery) include nylon, polyethylene terephthalate (PET), and laminated film of PET/nylon.

The positive electrode active material is not limited to lithium cobalt oxide. Other usable materials include lithium nickel oxide, lithium composite oxides containing cobalt, nickel, or manganese, such as lithium cobalt-nickel-manganese composite oxide, lithium aluminum-nickel-manganese composite oxide, and lithium aluminum-nickel-cobalt composite oxide, as well as spinel-type lithium manganese oxides.

As the negative electrode active material, various materials may be employed other than the graphite such as natural graphite and artificial graphite, as long as the material is capable of intercalating and deintercalating lithium ions. Examples include coke, tin oxides, metallic lithium, silicon, and mixtures thereof.

The electrolyte is not limited to that shown in the embodiments above, and various other substances may be used. Examples of the lithium salt include LiBF₄, LiPF₆, LiN(SO₂CF₃)₂, LiN(SO₂C₂F₅)₂, and LiPF_{6-X}(C₁F₂₊₁)_{X} (wherein 1<x<6 and n=1 or 2), which may be used either alone or in combination. The concentration of the supporting salt is not particularly limited, but it is preferable that the concentration be restricted in the range of from 0.8 moles to 1.8 moles per 1 liter of the electrolyte solution. The types of the solvents are not particularly limited to EC and MEC mentioned above. Examples of preferable solvents include carbonate solvents such as propylene carbonate (PC), γ-butyrolactone (GBL), ethyl methyl carbonate (EMC), dimethyl carbonate (DMC), and diethyl carbonate (DEC). More preferable is a combination of a cyclic carbonate and a chain carbonate.

The present invention is suitably applied to, for example, power sources for high-power applications, such as backup power sources and power sources for the motive power incorporated in robots and electric automobiles.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A laminate case secondary battery comprising: a stacked electrode assembly and a laminate battery case enclosing the stacked electrode assembly, the stacked electrode assembly comprising a plurality of positive electrode plates and a plurality of negative electrode plates being alternately stacked one another across separators, a plurality of positive electrode current collector leads and a plurality of negative electrode current collector leads protruding respectively from the positive electrode plates and the negative electrode plates and being respectively stacked on and joined to a positive electrode current collector terminal and a negative electrode current collector terminal, wherein: at least one of the positive electrode current collector terminal and the negative electrode current collector terminal has an L-shape in side view having a first piece substantially parallel to the positive electrode plates and the negative electrode plates of the stacked electrode assembly and a second piece substantially parallel to a stacking direction of the positive electrode plates and the negative electrode plates of the stacked electrode assembly; at least one of the positive electrode current collector leads and the negative electrode current collector leads is joined to the second piece of the at least one of the positive electrode current collector terminal and the negative electrode current collector terminal; and a glass tape is affixed to a stacking direction-wise fore-end region of a surface of the second piece, the surface of the second piece facing the laminate battery base, and the stacking direction being the stacking direction of the positive electrode plates and the negative electrode plates of the stacked electrode assembly.

2. The laminate case secondary battery according to claim 1, wherein the at least one of the positive electrode current collector terminal and the negative electrode current collector terminal and the corresponding electrode current collector leads are covered with an insulating layer containing ceramic particles.

3. The laminate case secondary battery according to claim 2, wherein the ceramic particles comprise at least one substance selected from the group consisting of alumina, titania, zirconia, and mullite.

4. The laminate case secondary battery according to claim 2, wherein the amount of the ceramic particles in the insulating layer containing the ceramic particles is from 85 mass % to 98 mass % with respect to the total amount of the insulating layer containing the ceramic particles.

5. The laminate case secondary battery according to claim 3, wherein the amount of the ceramic particles in the insulating layer containing the ceramic particles is from 85 mass % to 98 mass % with respect to the total amount of the insulating layer containing the ceramic particles.

6. The laminate case secondary battery according to claim 1, wherein the glass tape is affixed to an outer face of a boundary region between the first piece and the second piece of the current collector terminal.

7. The laminate case secondary battery according to claim 2, wherein the glass tape is affixed to an outer face of a boundary region between the first piece and the second piece of the current collector terminal.

8. The laminate case secondary battery according to claim 3, wherein the glass tape is affixed to an outer face of a boundary region between the first piece and the second piece of the current collector terminal.

9. The laminate case secondary battery according to claim 4, wherein the glass tape is affixed to an outer face of a boundary region between the first piece and the second piece of the current collector terminal.

10. The laminate case secondary battery according to claim 5, wherein the glass tape is affixed to an outer face of a boundary region between the first piece and the second piece of the current collector terminal.
